(19) United States
(12) Patent Application Publication
(10) Pub. No.: US 2015/0320028 A1
(43) Pub. Date: Nov. 12, 2015

(54) ELECTRONIC INSECT KILLING APPARATUS

(71) Applicant: Clear Innovation LLC, New York, NY (US)

(72) Inventor: Maurice S. Dayan, Oakhurst, NJ (US)

(21) Appl. No.: 14/707,728

(22) Filed: May 8, 2015

Related U.S. Application Data
(60) Provisional application No. 61/991,411, filed on May 9, 2014.

(51) Int. Cl. A01M 1/22; A01M 1/12; A01M 1/04; A01M 1/10

(52) U.S. Cl. CPC A01M 1/223; A01M 1/106; A01M 1/12; A01M 1/04

(57) ABSTRACT

An electronic insect killing apparatus. In one embodiment, the apparatus comprises a base housing a power source; a racket assembly coupled to the base, the racket assembly comprising: an insulating frame forming a central opening; an electrically conductive grid assembly operably coupled to the power source, the electrically conductive grid assembly positioned within the central opening of the insulating frame; at least one insulating strut located within the central opening, the at least one insulating strut formed of a phosphorescent material; and at least one electromagnetic radiation source operably coupled to the power source, the at least one electromagnetic radiation source configured to emit electromagnetic radiation onto the at least one insulating strut.

### CROSS REFERENCE TO RELATED APPLICATIONS

Priority is claimed U.S. provisional patent application Ser. No. 61/991,411, filed May 9, 2014, the disclosure of which is incorporated herein by reference in its entirety.

### BACKGROUND

Electronic insect killing devices have existed in different forms. Traditional bug zappers are sizeable appliances powered by mains electricity and typically hung. A light source attracts the bugs and, when sufficiently close, the bugs are electrocuted. By contrast, electronic flyswatters are handheld and battery-powered, and are generally used to swat at flying insects. But such devices have various drawbacks, including their failure to combine certain features of bug zappers and electronic flyswatters.

### BRIEF SUMMARY

The present invention is directed to an electronic insect killing apparatus. In one embodiment, the apparatus comprises a base housing a power source; a racket assembly coupled to the base, the racket assembly comprising: an insulating frame forming a central opening; an electrically conductive grid assembly operably coupled to the power source, the electrically conductive grid assembly positioned within the central opening of the insulating frame; at least one insulating strut located within the central opening, the at least one insulating strut formed of a phosphorescent material; and at least one electromagnetic radiation source operably coupled to the power source, the at least one electromagnetic radiation source configured to emit electromagnetic radiation onto the at least one insulating strut.

In another embodiment, the base comprises an upper and lower surface, wherein a center of gravity vector of the electric insect killing apparatus intersects the lower surface of the base when the lower surface of the base is in surface contact with a horizontal surface, thereby supporting the electric insect killing apparatus in a free-standing arrangement.

In another embodiment, the electronic insect killing apparatus comprises a base housing a power source, the base comprising an upper surface and a lower surface; a racket assembly coupled to and extending upward from the upper surface of the base, the racket assembly comprising: an insulating frame forming a central opening; an electrically conductive grid assembly operably coupled to the power source, the electrically conductive grid assembly positioned within the central opening of the insulating frame; and at least one electromagnetic radiation source operably coupled to the power source, the at least one electromagnetic radiation source configured to emit electromagnetic radiation onto portions of the electrically conductive grid assembly.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of an electronic insect killing apparatus in accordance with an embodiment of the present invention.

FIG. 2 is a front view of the electronic insect killing apparatus of FIG. 1.

FIG. 3 is a rear view of the electronic insect killing apparatus of FIG. 1.

FIG. 4 is a side view of the electronic insect killing apparatus of FIG. 1.

FIG. 5 is a wire view of the electronic insect killing apparatus of FIG. 1.

FIG. 6 is a cross-sectional view taken along line VI-VI of FIG. 2.

FIG. 7 is a cross-sectional view taken along line VII-VII of FIG. 4.

FIG. 8 is an exploded view of the electronic insect killing apparatus of FIG. 1.

FIG. 9 is a front view of an electronic insect killing apparatus in accordance with an alternative embodiment of the present invention.

### DETAILED DESCRIPTION

The following description of the preferred embodiment(s) is merely exemplary in nature and is in no way intended to limit the invention, its application, or uses.

The description of illustrative embodiments according to principles of the present invention is intended to be read in connection with the accompanying drawings, which are to be considered part of the entire written description. In the description of the exemplary embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “left,” “right,” “top,” “bottom,” “front” and “rear” as well as derivatives thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” “secured” and similar refer to a relationship wherein structures are secured or attached to one another either directly or indirectly through intervening structures, as well as both movable or rigid attachments or relationships, unless expressly described otherwise. Moreover, the features and benefits of the invention are described by reference to the exemplary embodiments illustrated herein. Accordingly, the invention expressly should not be limited to such exemplary embodiments, even if indicated as being preferred. The discussion herein describes and illustrates some possible non-limiting combinations of features that may exist alone or in other combinations of features. The scope of the invention is defined by the claims appended hereto.

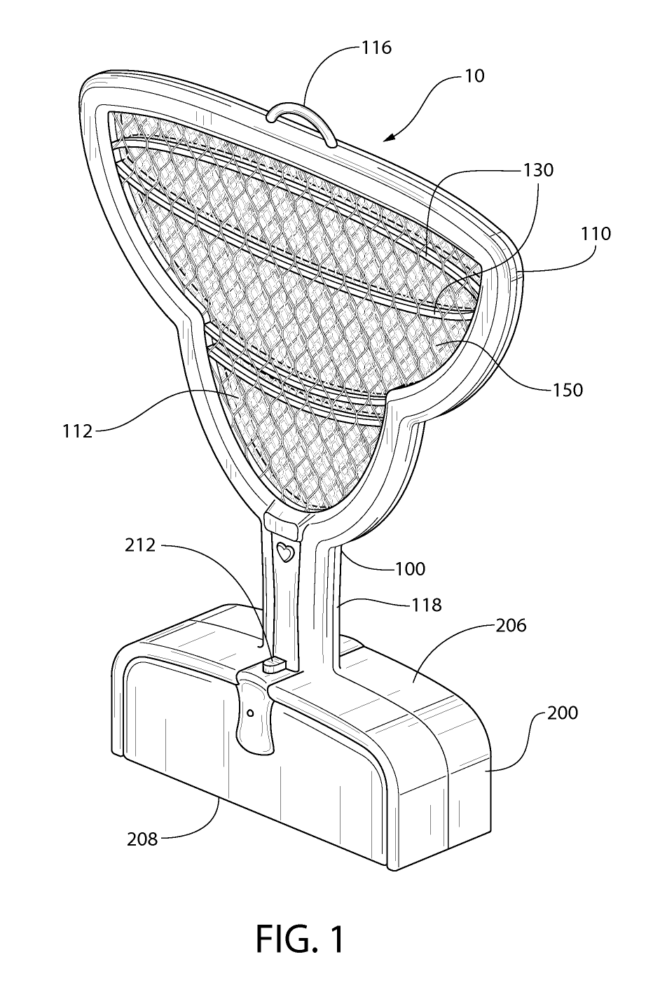

FIG. 1 shows an electronic insect killing apparatus 10 in accordance with an embodiment of the present invention. In this embodiment, the electronic insect killing apparatus 10 comprises a base 200 and a racket assembly 100. The base 200 houses a power source 204 and comprises an upper surface 206 and a lower surface 208. The racket assembly 100 is coupled to and extending upward from the upper surface 206 of the base 200. The racket assembly 100 comprises a post portion 118 and an insulating frame 110, which are discussed in further detail below. In the exemplified embodiment, the base 200 and racket assembly 100 are made of a hard plastic material. In other embodiments, the base 200 and racket assembly 100 can be made of other materials sufficient for providing the necessary structural support for the electronic insect killing apparatus 10, provided the insulating frame 110 is made of a dielectric material sufficient to provide insulation.

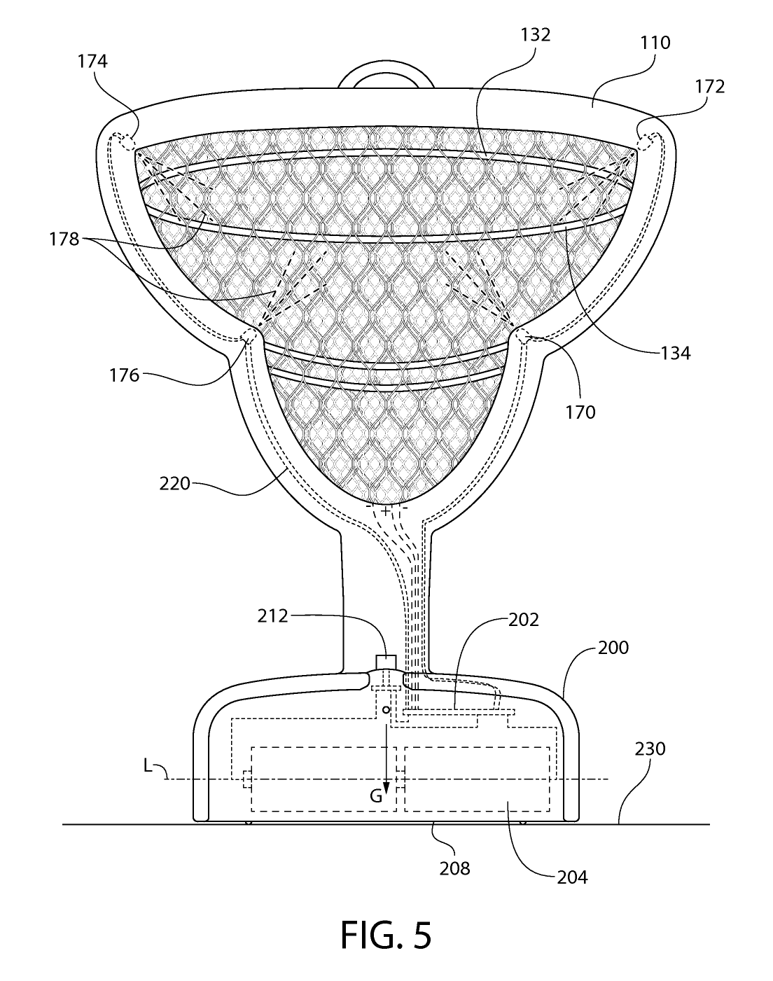

In the exemplified embodiment, the racket assembly 100 has a first depth measured from a front surface of the insulating frame 110 to a rear surface of the insulating frame 110; wherein the base 200 has a second depth measured from a front surface of the base 200 to a rear surface of the base 200; and wherein the first depth is less than one-half of the second depth. Further, as shown in FIG. 5, a center of gravity vector V of the electric insect killing apparatus 10 intersects the lower surface 208 of the base 200 when the lower surface 208 of the base 200 is in surface contact with a horizontal surface 230, thereby supporting the electric insect killing apparatus 10 in a free-standing arrangement. Thus, in the exemplified embodiment, the base 200 has a shape and weight sufficient to enable the electronic insect killing apparatus 10 to be free-standing. The invention is not so limited, however, as the base 200 can take on a variety of shapes, including shapes that are not free-standing. For example, the base could be in the form of a handle or a shape sufficient for hanging the electronic insect killing apparatus 10 from its base 200. The base 200 can also have a decorative shape or a shape for attaching to or resting upon a certain object or surface.

In the exemplified embodiment, as shown in FIG. 5, the power source 204 comprises two elongated “C” batteries extending along a longitudinal axis L. In other embodiments, the invention can use alternative power sources 204, such as other battery types (including AA, AAA, 9V batteries) or mains electricity, provided that the power sources, in combination with the circuit 202 of the apparatus 10, are capable of providing a sufficiently high voltage for electrocuting insects.

As also shown in FIG. 5, in the preferred embodiment, the lower surface 208 of the base 200 is in surface contact with the horizontal surface 230 and the longitudinal axis L of the batteries 204 is substantially parallel to the horizontal surface 230. Further, the longitudinal axis L of the batteries 204 is substantially parallel to the lower surface 208 of the base 200. As indicated above, however, the invention is not so limited. In alternative embodiments, the base can be shaped to be held or to attach to a particular surface such that the longitudinal axis L is not parallel to the horizontal surface 230, and/or not parallel to the lower surface 208 of the base 200.

Returning to FIG. 1, the racket assembly 100 of the preferred embodiment comprises an insulating frame 110 forming a central opening 112. Further, the racket assembly comprises a post portion 118 extending upward from the upper surface of the base, the insulating frame coupled to a top end of the post portion 118. In an alternative embodiment, the post portion 118 can be omitted such that the insulating frame 110 is connected directly to the base 200.

The racket assembly 100 comprises an electrically conductive grid assembly 150 operably coupled to the power source 204. As will be discussed in further detail below, the electrically conductive grid assembly 150 is located within the central opening 112 of the insulating frame 110 and provides an electrical charge for electrocuting an insect. The discussion below describes the exemplified embodiment for such an electrically conductive grid assembly, though any well-known arrangement using an electrically conductive grid to electrocute an insect could be considered an electrically conductive grid assembly 150.

Further, insulating struts 130 are located within the central opening. The invention can include one or more insulating struts 130. The struts 130 can be made of any phosphorescent material that can also function as a dielectric. In certain embodiments, the struts 130 provide insulation such that components of the electrically conductive grid assembly 150 remain spaced sufficiently apart, such that electrons do not flow between them. In other embodiments, the struts 130 can be located on the exterior of the electrically conductive grid assembly 150. The struts can be made of any phosphorescent material. Phosphorescent material is to be understood as material that uses phosphorescence to absorb radiation and re-emit that radiation at a lower intensity after the original excitation. In the preferred embodiment, only the insulating struts 130 are made of phosphorescent material. In alternative embodiments, the base 200 and/or insulating frame 110 can also be constructed of phosphorescent material.

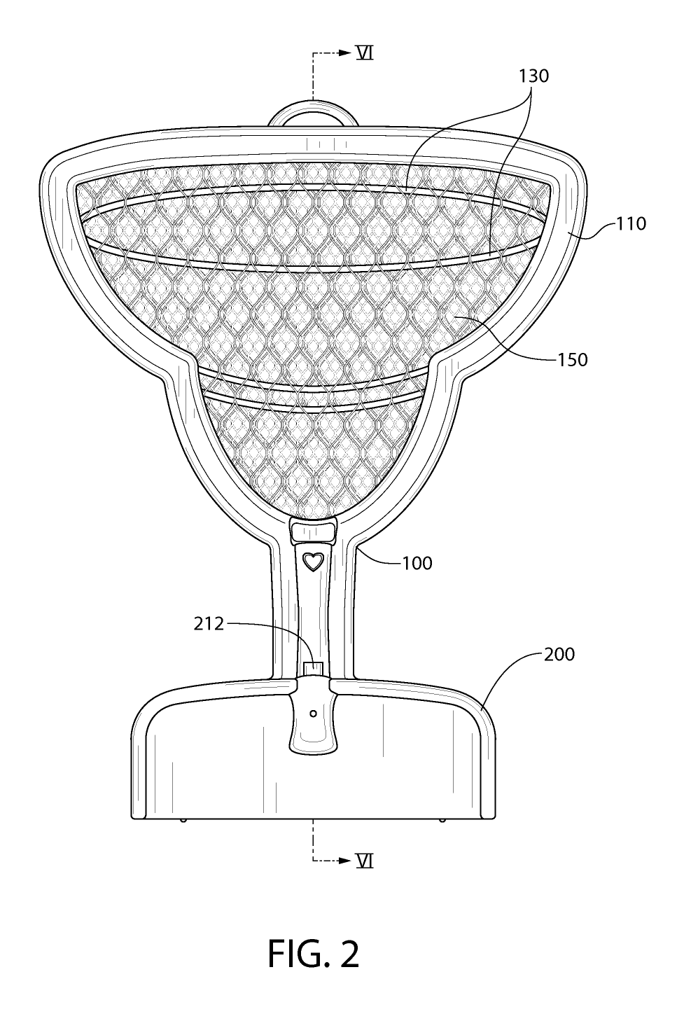

FIG. 2 is a front view of the electronic insect killing apparatus 10 of FIG. 1. This view again shows the base 200, switch 212, racket assembly 100, insulating struts 130, insulating frame 110, and electrically conductive grid assembly 150.

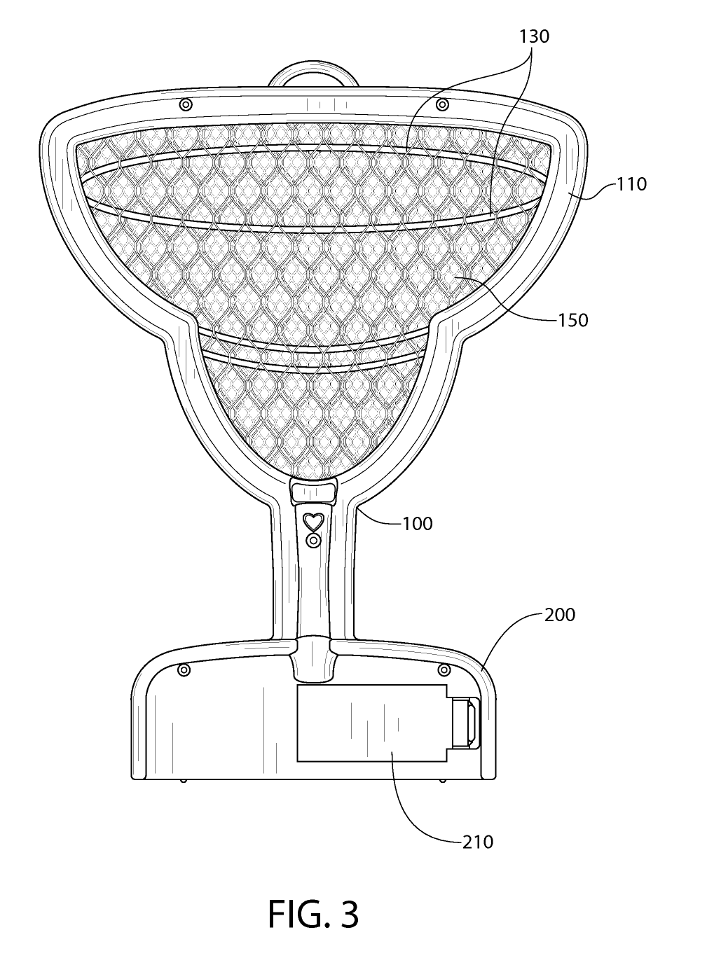

FIG. 3 is a rear view of the electronic insect killing apparatus 10 of FIG. 1. It shows a battery compartment 210 for receiving batteries.

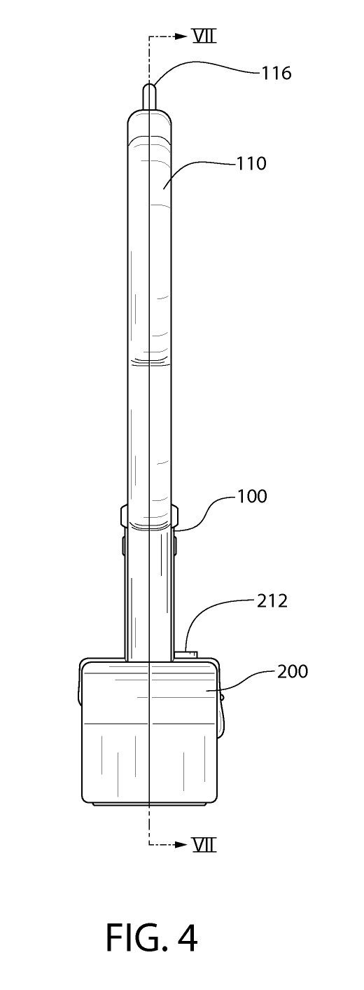

FIG. 4 is a side view of the electronic insect killing apparatus 10 of FIG. 1. Again are shown the racket assembly 100, insulating frame 110, base 200, and switch 212. In the exemplary embodiment, the racket assembly 100 further comprises a means 116 at a top portion of the insulating frame 110 for hanging the electronic insect killing apparatus 10. In this embodiment, the hanging means 116 is an aperture for receiving a hook or similar device. But the hanging means 116 could be replaced by any equivalent structure, including a hook, loop, fastener, screw, or adhesive.

FIG. 5 is a wire view of the electronic insect killing apparatus of FIG. 1. In the exemplified embodiment, the racket assembly 100 further comprises at least one electromagnetic radiation source 170 operably coupled to the power source, the at least one electromagnetic radiation source 170 configured to emit electromagnetic radiation 178 onto the at least one insulating strut 130. In this embodiment, the at least one electromagnetic radiation 170 source comprises a plurality of light sources 172 arranged along an inner periphery of the insulating frame 110 in a circumferentially spaced apart manner, the light sources 172 being light emitting diodes (“LEDs”). In alternative embodiments, the electromagnetic radiation source 170 can be light bulbs or any other device capable of providing electromagnetic radiation and can be placed in any manner sufficient to provide light to an insulating strut.

Further, electrical wires 220 electrically couple the power source 204 to the at least one source of electromagnetic radiation 170. The electrical wires 220 are at least partially located within a channel 114 of the insulating frame 110.

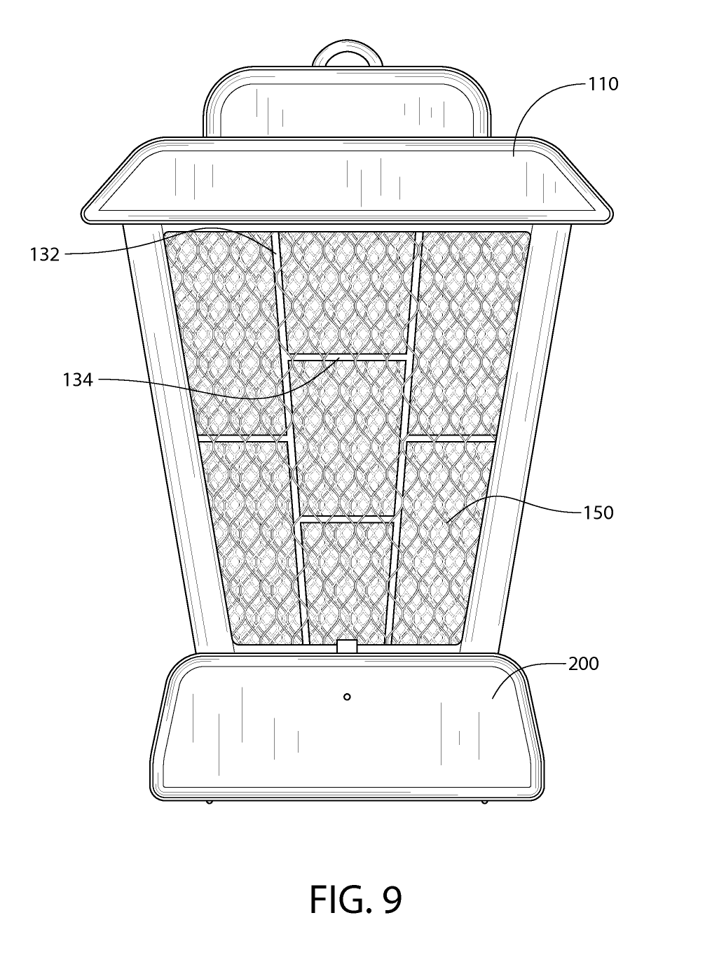

In the exemplified embodiment, the at least one insulating strut 130 comprises a first insulating strut 132 and a second insulating strut 134. A first one of the plurality of light sources (first light source 174) emits light onto the first insulating strut 132 and a second one of the plurality of light sources (second light source 176) emits light onto the second insulating strut 134. The first and second insulating struts 132, 134 are non-intersecting. Further, each of at least two of the plurality of light sources 172, 174 emit light onto the top area of at least one strut 132. In other embodiments, such as the alternative embodiment shown in FIG. 9, the first and second insulating struts 132, 134 can intersect one another in the central opening 112. Further, any number of struts 130 or light sources 172 can be used.

In the preferred embodiment, the electronic insect killing apparatus 10 comprises a switch 212 on the base 200 for coupling and decoupling the electrically conductive grid assembly 150 and the at least one source of electromagnetic radiation 170 from the power source 204. In alternative embodiments, the switch 152 can be positioned at other locations on the electronic insect killing apparatus 10, such as on the racket assembly 100. In certain embodiments, the switch 212 is activated by a push button. In other embodiments, the switch 212 can be a slide-actuated switch or another type of switch. The preferred embodiment further comprises a high voltage circuit 202 located within the base and operably coupled to the electrically conductive grid assembly 150 and the power source 204. In an alternative embodiment, the circuit 202 can be located outside the base 200, for example in the insulating frame 110.

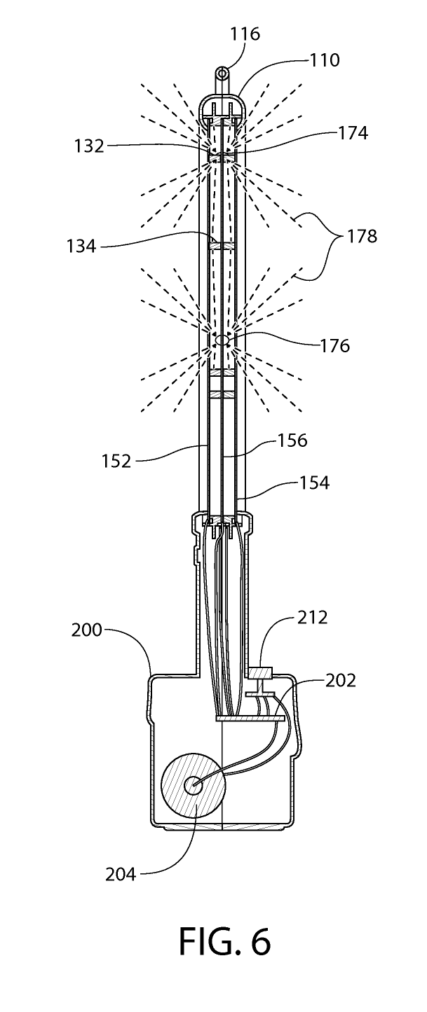

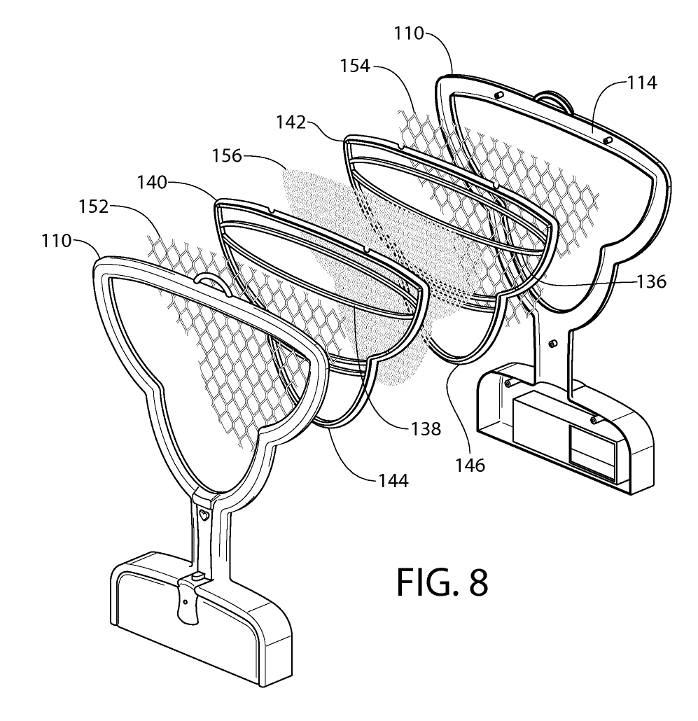

FIG. 6 is a cross-sectional view taken along line VI-VI of FIG. 2. This illustration further shows how, in the preferred embodiment, the light sources 174, 176 shine light 178 on the insulating struts 134. This figure further shows components of the base 200, including the switch 212, circuit 202, and power source 204. This figure further shows the electrically conductive grid assembly comprising three separate grids 152, 154, 156, which will be discussed in further detail with regard to FIG. 8.

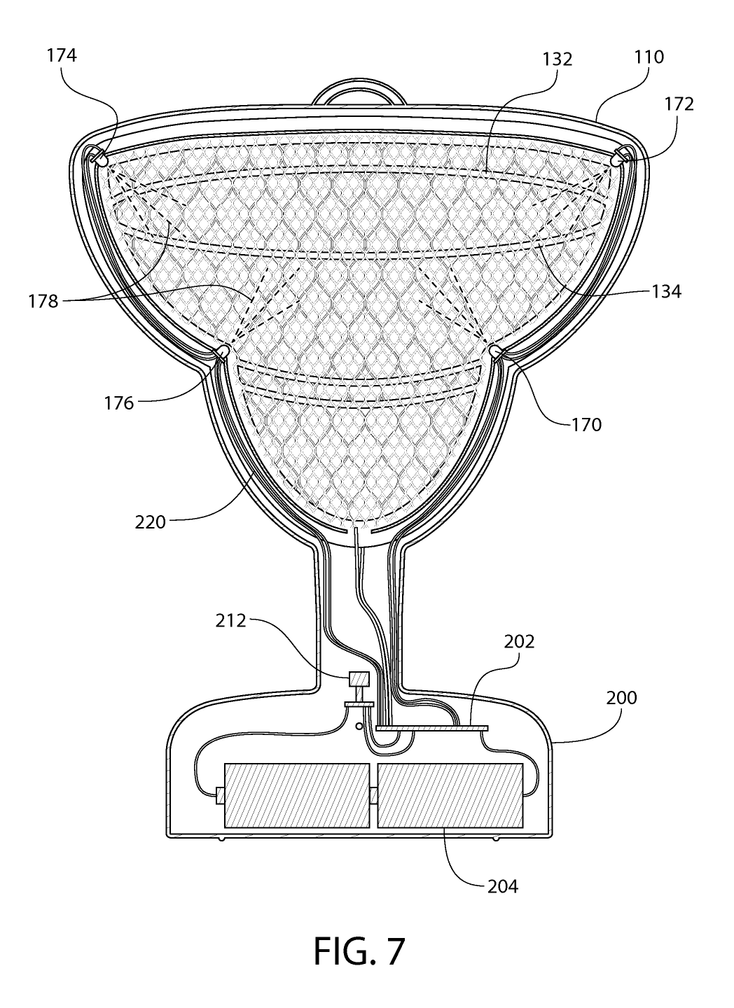

FIG. 7 is a cross-sectional view taken along line VII-VII of FIG. 4. As can be seen, the exemplified embodiment includes the insulating frame 110, light sources 170, 172, 174, 176, first and second insulating struts 132, 134, the base 200, the circuit 202, the power source 204, the switch 212, the electrical wires 220, and the light 178.

FIG. 8 is an exploded view of the electronic insect killing apparatus 10 of FIG. 1. In this exemplified embodiment, the electrically conductive grid assembly 150 comprises a first grid 152 having a negative charge, a second grid 154 having a negative charge, and a third grid 156 having a positive charge, the first, second, and third grids 152, 154, 156 supported in the central opening 112 in a spaced-apart manner, the third grid 156 positioned between the first and second grids 152, 154. The grids can be of any pattern provided they provide space for an insect to make simultaneous contact with the third (center) grid 156 and one of the other grids 152, 154.

In the exemplified embodiment, when switched on, the circuit takes power from the two C batteries in series (approximately 3.0 volts) and boosts the voltage. The boosted voltage can be 500 to 2500V, or any voltage necessary to electrocute the targeted insect. This voltage is then provided to the third grid (the “positive grid”) 156. The first and second grids (the “negative grids”), 152, 154, by contrast, are connected with the negative terminal of the power source 204. The positive grid 156 is separated from the negative grids 152, 154 at a sufficient distance to prevent shorting the circuit during normal handling. But when an insect makes contact with the positive grid 156 and one of the negative grids 152, 154, the insect creates a low resistance path in between the positive grid 156 and negative grid 152, 154 such that electricity passes through the insect and the insect is electrocuted. The circuit 202 also provides power to the light sources 172.

In the exemplified embodiment, the first, second, and third grids 152, 154, 156 are planar. In alternative embodiments, the grids 152, 154, 156 could take non-planar shapes provided that the grids are a sufficient distance apart to both (1) allow insects to contact a positive and negative grid to be electrocuted and (2) prevent a short during normal handling.

FIG. 8 further shows how the racket assembly 100 of the exemplified embodiment further comprises a first insulating spacer 140 positioned between the first and third grids 152, 154 and a second insulating spacer 142 positioned between the second and third grids 154, 156. Further, the at least one insulating strut 130 is formed by a first strut portion 138 of the first insulating spacer 140 and a first strut portion 136 of the second insulating spacer 142. The spacers 140, 142 can be shaped and made from any dielectric material sufficient to enable space between the grids. In alternative embodiments, one or both of the spacers 140,142 can be omitted.

In the exemplified embodiment, the first insulating spacer 140 comprises a first annular portion 144 nesting within a channel 114 of the insulating frame 110, the first strut portion 138 of the first insulating spacer 140 coupled to the first annular portion 144; and wherein the second insulating spacer 142 comprises an annular portion 146 nesting within the channel 114 of the insulating frame 110, the first strut portion 136 of the second insulating spacer 142 coupled to the second annular portion 146. In alternative embodiments, the annular portion could be omitted in favor of any other attachment mechanism, such as periodic snaps or adhesive.

What is claimed is:

1. An electronic insect killing apparatus comprising:
a base housing a power source, the base comprising an upper surface and a lower surface;
a racket assembly coupled to and extending upward from the upper surface of the base, the racket assembly comprising:
an insulating frame forming a central opening;
an electrically conductive grid assembly operably coupled to the power source, the electrically conductive grid assembly positioned within the central opening of the insulating frame;
at least one insulating strut located within the central opening, the at least one insulating strut formed of a phosphorescent material; and
at least one electromagnetic radiation source operably coupled to the power source, the at least one electromagnetic radiation source configured to emit electromagnetic radiation onto the at least one insulating strut; and
wherein a center of gravity vector of the electric insect killing apparatus intersects the lower surface of the base when the lower surface of the base is in surface contact with a horizontal surface, thereby supporting the electric insect killing apparatus in a free-standing arrangement.

2. The electronic insect killing apparatus of claim 1 wherein the power source comprises at least one elongated battery extending along a longitudinal axis; and wherein when the lower surface of the base is in surface contact with the horizontal surface, the longitudinal axis of the at least one battery is substantially parallel to the horizontal surface.

3. The electronic insect killing apparatus of claim 1 wherein the power source comprises at least one elongated battery extending along a longitudinal axis; and wherein the longitudinal axis of the at least one battery is substantially parallel to the lower surface.

4. The electronic insect killing apparatus of claim 1 wherein the at least one electromagnetic radiation source comprises a plurality of light sources arranged along an inner periphery of the insulating frame in a circumferentially spaced apart manner.

5. The electronic insect killing apparatus of claim 4 wherein each of the plurality of light sources comprises a light emitting diode.

6. The electronic insect killing apparatus of claim 4 wherein the at least one insulating strut comprises a first insulating strut and a second insulating strut; and wherein a first one of the plurality of light sources emits light onto the first insulating strut and a second one of the plurality of light sources emits light onto the second insulating strut.

7. The electronic insect killing apparatus of claim 6 wherein the first and second insulating struts are non-intersecting.

8. The electronic insect killing apparatus of claim 6 wherein the first and second insulating struts intersect one another in the central opening.

9. The electronic insect killing apparatus of claim 4 wherein each of at least two of the plurality of light sources emit light onto the same area of the at least one strut.

10. The electronic insect killing apparatus of claim 1 wherein the electrically conductive grid assembly comprises a first grid having a negative charge, a second grid having a negative charge, and a third grid having a positive charge, the first, second and third grids supported in the central opening in a spaced-apart manner, the third grid positioned between the first and second grids.

11. The electronic insect killing apparatus of claim 10 wherein each of the first, second and third grids are planar.

12. The electronic insect killing apparatus of claim 10 wherein the racket assembly further comprises: a first insulating spacer positioned between the first and third grids; and a second insulating spacer positioned between the second and third grids.

13. The electronic insect killing apparatus of claim 12 wherein the at least one insulating strut is formed by a first strut portion of the first insulating spacer and a first strut portion of the second insulating spacer.

14. The electronic insect killing apparatus of claim 13 wherein the first insulating spacer comprises a first annular portion nesting within a channel of the insulating frame, the first strut portion of the first insulating spacer coupled to the first annular portion; and wherein the second insulating spacer comprises an annular portion nesting within the channel of the insulating frame, the first strut portion of the second insulating spacer coupled to the second annular portion.

15. The electronic insect killing apparatus of claim 1 wherein the racket assembly further comprises means at a top portion of the insulating frame for hanging the electronic insect killing apparatus

16. The electronic insect killing apparatus of claim 1 further comprising a switch on the base for coupling and decoupling the electrically conductive grid assembly and the at least one source of electromagnetic radiation from the power source.

17. The electronic insect killing apparatus of claim 1 wherein the racket assembly further comprises a post portion extending upward from the upper surface of the base, the insulating frame coupled to a top end of the post portion.

18. The electronic insect killing apparatus of claim 1 further comprising electrical wires electrically coupling the power source to the at least one source of electromagnetic radiation, the electrical wires at least partially located within a channel of the insulating frame.

19. The electronic insect killing apparatus of claim 1 wherein the racket assembly has a first depth measured from a front surface of the insulating frame to a rear surface of the insulating frame; wherein the base has a second depth measured from a front surface of the base to a rear surface of the base; and wherein the first depth is less than one-half of the second depth.

20. The electronic insect killing apparatus of claim 1 wherein each of the base and the annular frame are constructed of the phosphorescent material.

21. The electronic insect killing apparatus of claim 1 further comprising a high voltage circuit located within the base and operably coupled to the electrically conductive grid assembly and the power source.

22. An electronic insect killing apparatus comprising:
a base housing a power source;
a racket assembly coupled to the base, the racket assembly comprising:
an insulating frame forming a central opening;
an electrically conductive grid assembly operably coupled to the power source, the electrically conductive grid assembly positioned within the central opening of the insulating frame;
at least one insulating strut located within the central opening, the at least one insulating strut formed of a phosphorescent material; and
at least one electromagnetic radiation source operably coupled to the power source, the at least one electromagnetic radiation source configured to emit electromagnetic radiation onto the at least one insulating strut.

23. The electronic insect killing apparatus of claim 22 wherein the at least one electromagnetic radiation source comprises a plurality of light sources arranged along an inner periphery of the insulating frame in a circumferentially spaced apart manner.

24. The electronic insect killing apparatus of claim 23 wherein the at least one insulating strut comprises a first insulating strut and a second insulating strut; and wherein a first one of the plurality of light sources emits light onto the first insulating strut and a second one of the plurality of light sources emits light onto the second insulating strut.

25. The electronic insect killing apparatus of claim 23 wherein each of at least two of the plurality of light sources emit light onto the same area of the at least one strut.

26. The electronic insect killing apparatus of claim 22 wherein the electrically conductive grid assembly comprises a first grid having a negative charge, a second grid having a negative charge, and a third grid having a positive charge, the first, second and third grids supported in the central opening in a spaced-apart manner, the third grid positioned between the first and second grids.

27. The electronic insect killing apparatus of claim 26 wherein the racket assembly further comprises: a first insulating spacer positioned between the first and third grids; and a second insulating spacer positioned between the second and third grids.

28. The electronic insect killing apparatus of claim 27 wherein the at least one insulating strut is formed by a first strut portion of the first insulating spacer and a first strut portion of the second insulating spacer.

29. An electronic insect killing apparatus comprising:
a base housing a power source, the base comprising an upper surface and a lower surface;
a racket assembly coupled to and extending upward from the upper surface of the base, the racket assembly comprising:
an insulating frame forming a central opening;
an electrically conductive grid assembly operably coupled to the power source, the electrically conductive grid assembly positioned within the central opening of the insulating frame; and
at least one electromagnetic radiation source operably coupled to the power source, the at least one electromagnetic radiation source configured to emit electromagnetic radiation onto portions of the electrically conductive grid assembly.
